(19) United States
(12) Patent Application Publication
(10) Pub. No.: US 2003/0172380 A1
(43) Pub. Date: Sep. 11, 2003

(54) Audio command and response for IPGs

(76) Inventor: Dan Kikinis, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/351,027

(22) Filed: Jan. 25, 2003

Related U.S. Application Data
(63) Continuation-in-part of application No. 09/875,547, filed on Jun. 5, 2001.
(63) Continuation-in-part of application No. 09/875,546, filed on Jun. 5, 2001.
(60) Provisional application No. 60/352,142, filed on Jan. 25, 2002.

(51) Int. Cl. G06F 3/00; H04N 5/445; G06F 13/00

(52) U.S. Cl. 725/39; 725/37; 725/56

(57) ABSTRACT

An apparatus comprising a first unit to provide an Electronic progaming guide (EPG), a second unit to operate the EPG in response to voice commands, and a third unit to produce an audibile response.

This application is a continuation-in-part of U.S. patent applications No. 09/875,547 filed Jun. 05, 2001 and 09/875,546 filed Jun. 05, 2001 and are incorporated herein by reference. Applicant claims priority to U.S. provisional application No. 60/352,142 filed Jan. 25, 2002 titled “Audio Command and Response for IPGs” (Attorney Docket No. 4688.P079z), to U.S. provisional application No. 60/224,822, filed Aug. 11, 2000, U.S. application No. 09/875,547 filed Jun. 5, 2003 titled “Enhanced Home Entertainment System With Removable Long-Term Storage for Digital Media” (Attorney Docket No. 4688.P027), to U.S. patent application Ser. No. 09/488,361, filed Jan. 16, 2000 and claims priority to provisional U.S. application No. 60/215,681, filed Jun. 30, 2000, and copending U.S. application No. 09/858,762 filed May 15, 2003 titled “Transparent Object Management for Removable Media Recorders” (attorney docket no. 4688.P022), and U.S. application No. 09/8 75,546 filed Jun. 5, 2001 titled “Remote Control of TV Programming” (Attorney Docket No. 4688.P023) all aforementioned applications are incorporated herein by reference.

### BACKGROUND

TV guides in past and current usage have been typically confined to appearing on the TV screen itself, most importantly because the cost of the display device, typically the TV or other monitor or projection systems also used to display information, was the single most expensive component in the system. As a result, TV systems have always tried to give this screen dual-use function, insofar as they had the ability to display programming information, the actual programs, or a combination of the programming information and a program.

The disadvantage of this approach, however, is that it can greatly reduce or even negate the enjoyment of the viewing experience of other people in the room when one person is viewing the schedule. In such a one-screen system, either the schedule is superimposed or replaces the programming, or, in probably the least intrusive way, is inserted in the picture-in-picture, where it may be hard to read, or the main program runs in the picture-in-picture, so viewers don't completely miss out while browsing through the programming information.

What is clearly needed is an improved method that allows viewers to browse TV programming information without having to interrupt or even reduce their own and other viewers' enjoyment of viewing the main program.

Furthermore, it is desirable that several people be able share programming of entertainment center selections. As PDAs, Web phones, etc., become more widespread, it becomes more likely that each member of the family may have their own device that can be used as a program/programming guide, and for preselection of programs for later viewing and/or recording. Such personalized preprogramming, when stored on a server such as, for example, server 130, gives users an option to download and view their preprogrammed entertainment selections not just at one's home base, but also at other places where one might want to go, for example, a friend's home, hotels, etc. Additionally, a group of people may have some type of an interactive selection process to decide which program to view when later gathered together as a group, for example, on an evening at home, while various members of the group are currently viewing programming information while away from the entertainment center location.

Furthermore, today when certain interactive TV systems, such as Wink™, WebTV™, or MSTV™, create applications, they need to show users that interactive information or service is available in this program. For example, Wink uses its own logo, or the MSTV manual recommends using a line at the bottom of the program window to say that interactive service is accessible now. What is needed is a more natural way to let the user know that interactive functions are available, without disturbing the viewing experience of all viewers.

A further example of such a natural method of communicating with users is voice input into a remote control device, allowing simple, low-cost voice commands for controlling and programming a home entertainment system.

When a home entertainment system contains all the functionalities that are available today, such as set-top box, Web browser, TiVo or Replay box (hard disk recorder), regular VCR, DVD player, enhanced sound system and/or TV projector, several problems can arise. In the first place, multiple signal conversions between different devices sometimes lead to a visible degradation of signal quality. Also, setting up and wiring such a full-featured system is so complicated that it often exceeds the capabilities of normal users. Additionally, when each device has its own input and output ports, certain configuration combinations are not possibly available. Last but not least, even if the user is capable of getting the system wired, he will end up with such a daunting array of remote control and other interface devices, such as keyboard and pointing devices, that it almost requires a Ph.D. to operate such a complex entertainment center. Such a situation is not productive and it holds back the industry.

What is clearly needed is a simplified system that is much more cost effective and at the same time makes life easier for the user by offering a whole host of very simple integrated commands addressing all the usage possibilities that may arise.

An Electronic Programming Guide (EPG) displays information about programs a viewer is currently watching as well as information about other programs on different channels or at different times. The first EPGs were typically displayed on one channel of a cable television system. These early EPGs were simple, displaying short program descriptions and scrolling past the screen at a predetermined rate. Also, these EPGs typically did not allow for user interaction. More recent digital EPGs allow for the user to interact with the programming schedule, and to view programs while scanning the guide. However, digital EPGs still typically rely on the television as a means of showing the EPG.

FIG. 39-1 illustrates a typical home entertainment system. Home entertainment system 10 comprises signal input 15, set-top box 20, television based web-browser 25, recording device 30, auxiliary recording device 35, stereo receiver 40, digital versatile disk (DVD) player 45, and television or other video monitor 50.

Entertainment system 10 could have, in addition to the connections shown, networking connections for set-top box 20, web-browser 25, and recording device 30. Many of these devices require either telephone connections or Internet connections in order to program them.

Entertainment system can be difficult for the novice user to set up. Additionally, because the connections between the components are typically analog, the number of connections between input 15 and television 50 can seriously degrade the signal quality.

What is needed is a way to simplify the connections required for an entertainment system, in addition to reducing the amount of signal degradation present in the typical entertainment system.

What is clearly needed is a multimedia-enabled access to the IPG that allows access across multiple media.

### BRIEF DESCRIPTION OF THE DRAWINGS

FIG. 39-1 is a prior art system diagram.

FIG. 39-2 is a system diagram.

FIG. 39-3 is a system diagram.

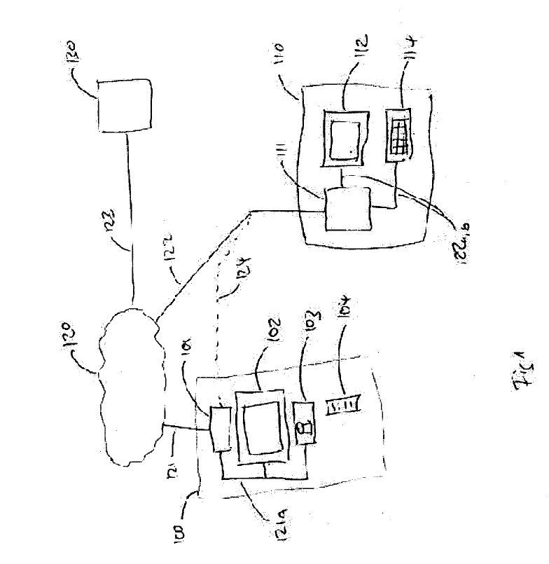

FIG. 1 is a system diagram according to one embodiment.

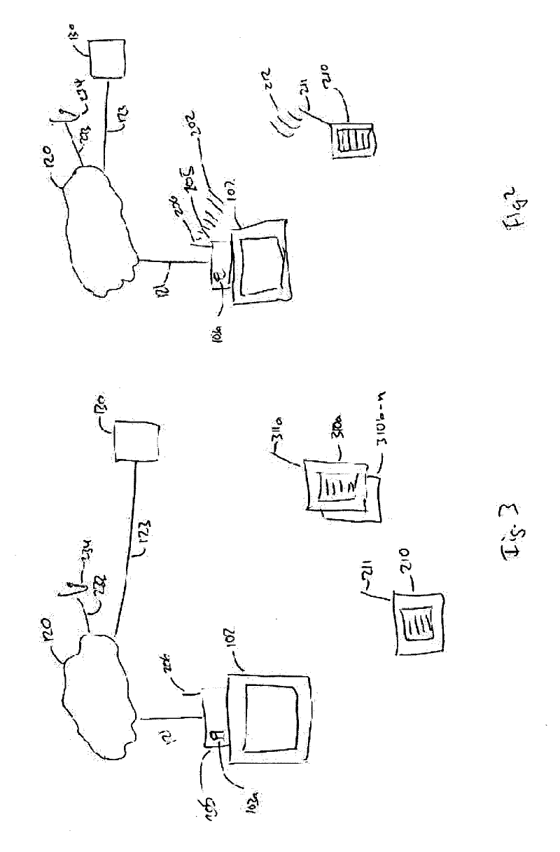

FIG. 2 is a system diagram according to one embodiment.

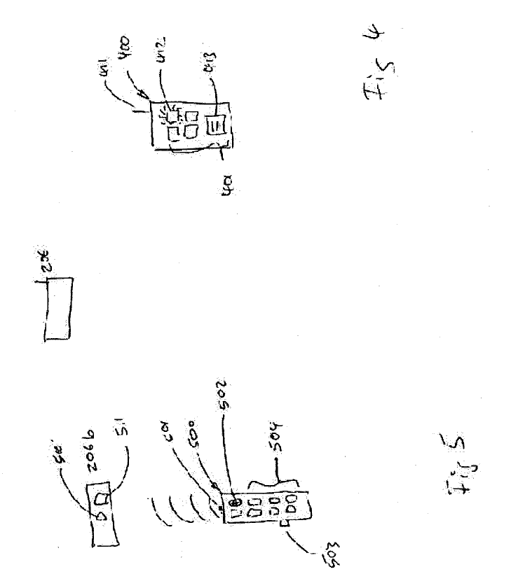

FIG. 3 is a system diagram according to one embodiment.

FIG. 4 is a system diagram according to one embodiment.

FIG. 5 is a system diagram according to one embodiment.

FIG. 6 is a flow diagram.

FIG. 7 is a system diagram according to one embodiment.

### DESCRIPTION OF THE EMBODIMENT

The increasing number of additional display devices in homes, such as PCs, PDAs, Web phones, etc., now offer the opportunity to permit viewers to browse TV programming information on a second display device.

FIG. 1 shows a simplified overview of entertainment system 100. It contains monitor or TV 102 (or any equivalent projection device, such as a plasma or LCD, etc.), set-top box 101, and digital or other recording device 103. Recording device 103 could be any one of a wide variety of recording devices, such as VCR, hard disk, DVD RAM, etc.

Set-top box 101 can receive signals from network 121, but it is also capable of additional connections, such as connection 121a, to monitor 102 and to recording device 103.

Also shown in entertainment system 100 is a classic remote controller 104 that has buttons and in some cases has some text on the buttons. Controller 104 controls other entertainment system devices typically by infrared but in some cases also RF technologies.

Network feed 121 into set-top box 101, as described before, could be actually from a single network 120 or a combination of multiple networks. It could deliver signals over a regular LAN or LAN/WAN combination or a satellite broadcast; it could be cable with analog, digital or HDTV broadcasts, or any combination thereof. Additionally, network feed 121 may also contain unidirectional or bidirectional Internet access through one of those media or separately, or through an additional medium where bidirectional data is possible, for example, such as the well-known DirecPC® by Hughes Network Systems (see http://www.direcpc.com).

The most characteristic embodiment for all these networks would be a single high-bandwidth digital network that allows both digital video streams and Internet access as well as other services to run on the same network, preferably over fiber optic cable; however, the media and the types of networks and combinations should not be deemed special or restrictive for this embodiment.

Though there are nearly limitless other possibilities, only a single network cloud 120 is shown in this embodiment for both data and broadcast information. One such broadcast server 130, which has viewable programs that can be viewed and recorded in system 100, delivers its information through link 123 into the cloud.

Another device connected to a network is computing system 110. It has a simple link 122 into network cloud 120 (which might also be or include the Internet). In some cases the computing device may be located near entertainment system 100 but, rather than being connected to network 120 through direct connection 122, system 110 may be connected by in-house connection 124 to set-top box 101. Set-top box 101 then could act as a router and possibly transfer Internet or other network requests through its own link 121 into the network cloud, while also being able to communicate directly with computing system 110.

Computing system 110 consists of computer 111, such as a PC or PDA, Web phone, etc., having a display device 112, which may be a monitor or an LCD or, as in the case of a PDA, an integrated display device, typically LCD, and an input device, here shown only as keyboard 114 (dedicated, programmable or generic), although it is well known in the art that mice, trackballs, etc., can also be used, alone or in combination. Additionally, all the necessary connections are simplified here to show only connections 122a and 122b.

As shown in FIG. 1, it is now possible for several people watch a program on display 102, while one or more of these people may also use computing device 110 to view programming information on screen 112. Those people viewing programming information on computing device 110 can make selections and possibly even view local previews on screen 112, while the main event on screen 102 is completely undisturbed, allowing viewers to choose whether to watch the main event or to try to participate in the program selection. P Program information may be downloaded to device 111 either from set-top box 101 or from a server in the network, which might, in our example, be the same as the broadcast server 130.

Information viewed on screen 112 can be manipulated by input device 114, and certain selections may be made and sent via a networking connection, either 122, or 124, or any similar combination either to server 130 or directly to set-top box 101. In any event, such selections made from computing device 110 may then be used on entertainment system 100 to actuate viewing selections or preprogram reminders for viewing selections, or actuate recording events or preprogram recording events, or any combination thereof. In some cases, rather than actuating on the exact time, the system (recording system, viewing system, or both) can be activated a short period before the time, and also de-activated for a short period after the time, to compensate for a small inaccuracy in actual vs. scheduled broadcast time. In some cases a server controls the actuation, e.g., server 130, to relieve the system 100 from the task of scheduling programs.

Additionally, upon pushing certain command buttons, selected information may also be viewed on screen 102. This feature permits a variety of convenient information sharing, such as discussing with other people in the room which program to view, if screen 112 is too small to share, or making information available to some person seated or lying in view of display 102, whose mobility is impaired such that he or she is prevented from moving to view display 112.

However, in such a situation, screen 102 would merely reflect a limited selection transmitted to box 101 or activated in box 101 on command of computing device 110. This may be done directly, via the network, or via a server, such as 130.

FIG. 2 shows an example of such an implementation, using set-top box 205 with integrated recording device (hard disk 103a), on monitor 102. Set-top box 205 has also an integrated antenna 206 which is used to transmit radio waves 202 back and forth to and&from hand-held unit 210, which has its own antenna 211 and can transmit and receive radio waves 212. Unit 210 could, for example, be a PDA device fitted with something such as a Bluetooth™ interface, which is an in-home networking standard for short-range applications. Antenna 206 may be connected to an equivalent Bluetooth interface in box 205 (see http://www. bluetooth.org).

FIG. 3 shows essentially the same entertainment system as appears in FIG. 2, slightly simplified, showing only set-top box 205 with integrated recording mass storage device 103a, which may be a fixed or removable disk, and antenna 206, which allows communications via Bluetooth, for example, to PDA 210 with antenna 211. But any other method of wired or wireless communication, including but not limited to LANs, RF, IR, magnetic, UWB, etc., shall be deemed equivalent. Additional PDAs 310a, with antennae 311a, and 310b through n are shown. These devices may either connect to a Bluetooth base station by antenna 206 and unit 205, or they may connect via public network (not shown, e.g., cellular, PCM, satellite etc.) into network cloud 120, and from there either connect directly to entertainment system 205 or alternatively to server 130.

Using the server connection is advantageous when a person may not be sure where he might be when he wants to view an entertainment selection. A selection might be downloaded from server 130 to any of various places, such as, for example, a friend's home, a hotel room, etc. Also, the recording can be programmed and recorded completely unattended, in the complete absence of the user, even while user is still travelling.

In other cases, recordings might be even out-sourced into a spindle farm, also called a storage area network (SAN, not shown), a system in which multiple recording disks are attached to a network, connected and controlled via server 130, and programs may be viewed later.

Besides PDAs, other computing devices, appliances, Web phones, electronic books, or any kind of appliance, even those using voice recognition as an input, which could offer the opportunity for a discussion of a programming guide, rather than just browsing and viewing, might be used to gather information about which program to mark for viewing and/or recording.

In the case of spindle farm recordings, copyright issues might arise, because even though these recordings would be only for personal use, the content provider might argue that it is a violation of their copyright. By having a recording device in entertainment center 205, such issues should not arise.

Capacity extension may be done by, for example, using a DVD juke box rather than a simple hard disk. Applying today's existing technologies of carousels of up to 400 CD ROMs to DVD RAM would allow recording of up to 400 DVD RAMs, each with about 2 to 4 hours of high-quality program recording.

By integrating the programming guide and the recordings, those DVDs could be automatically catalogued and indexed and easily retrieved for later use in a carousel. Alternatively, labels could be printed with associated bar codes, or you could add unique serial numbers as IDs on the DVDs, for automatic indexing when reintroduced into the system.

FIG. 4 shows a novel method for indicating to viewers that interactive information or services are available in a program. Remote control 400 has an antenna 411 for communication with base station 206 that is the home entertainment center. It has a display 413 with three lines of text showing and input/output elements 401. In this case, for example, button 412 is flashing (as indicated by the halo around button 412); in other cases, for example, the LCD backlight of 413 may blink blue instead of white or green when in normal use. Also in some cases a beeper or microspeaker on remote 400 (not shown) may create a sound or play a sound file to indicate interactivity.

An interactive application sends a signal to TV, monitor, receiver etc, and/or to remote controller at the same time. Bluetooth, or any other wireless technologies may be used, including but not limited to IR, RF, magnetic induction, ultrasonic etc. Those can send commands to the RC and allow it to recognize the signal and for example turn on or off a light at a button of RC, or backlight the RC panel, in some cases by special color light. Also, in some cases, sound clips may be sent using those connections, and special sounds, words etc may be played at the RC, whether it is a dedicated RC for a single appliance, a multi device RC, or a PDA or other similar computing device connected over a network.

In some cases, a simulcast interaction triggering signal to TV and RC (including possible PDA) or other appliances may be sent, and additional intelligence in the RC allows it to react to the correct signal by light, sound, or any other way, even by odor or temperature variations, in the case of adaptations for persons with impaired senses.

In yet other cases, the remote control device, for example, may contain a microphone that allows the user to speak commands. Such a remote control device may be designed, for example, so the microphone can be brought close to the user's mouth, reducing problems of background noise. The commands thus captured may then be digitized and sent to the respective controlled device, including but not limited to a TV, monitor, set-top box, home entertainment system etc.

FIG. 5 shows a simple remote control device 500 using infrared transmitter 501 to send commands to set-top box 206b with infrared receiver 510. Symbolically shown is processor 511 (only symbolically shown; obviously it has to be a CPU with memory and all the required I/O). Processor 511 then processes the digital voice file that has been recorded in remote control 500 and is then executing commands accordingly.

Element 502 is the microphone into which the user would speak, and element 503 is shown as a Record button on the side of the remote control; however, such a button may not be necessary, as, for example, voice activation may turn on the system when the voice is loud enough or when a key word is spoken. In some types of transmission, for example, infrared transmission, due to the slow speed, the voice needs to be stored in a flash or RAM inside the remote control until all of it can be transmitted to the set-top box.

In cases of wireless transmissions such as Bluetooth, etc., the transmission speed would be, in most cases, high enough so that no substantial storage is required. However, today, very inexpensive chips can be found in the market, such as those used in voice memo recorders, which can record up to 10 or 20 seconds of voice, a period that is more than sufficient to record very complex commands.

In the least expensive case, a microphone could allow a voice command to be recorded digitally in the remote control, and then sent by infrared transmission to a TV or set-top box, where the processing then can take place, without power and CPU restrictions. In some cases, pushing a button, similar to a record button, can indicate that the recorded input is a command.

Also, voice prints, which have unique features from person to person, obtained in such a way may be used for authentication, in cases such as parental control, e-commerce, etc.

FIG. 6 shows a system that could be constructed using today's existing devices. Input from the cable, satellite antenna, etc., comes over line 620 (typically RF with analog and/or digital TV signals) into set-top box 610, which then decodes only one channel at a time. The signal then is passed via connection 621 (which might be RF or video or S-video, depending on the connections available in the set-top box and on the receiving box actually used) into a TV/Web browsing appliance 611, for example, a Microsoft™ WebTV™ box (actual box manufactured by hardware OEM, such as Sony, Philips, etc.). Then connection 622 passes the output of box 611 to disk recording device 612, such as TiVo, Replay TV, or another equivalent disk recording device that uses a hard disk for recording. Hard disk recording device 612 may also have a separate port or some type of connection to VCR 613 (perhaps tied via wires 622 and 624). Device 611 is then connected to surround sound system 614, which also has a connection, for example, via wiring 625 to DVD player 615. The output of surround sound system 614 is then sent via wiring 626 to TV or TV projection system 616.

Not shown are potential telephony or other networking connections for the TV box, the WebTV box, and the set-top box. Such connections are very often required to program those devices, for downloading schedule information, other high-end functions, and, in the case of WebTV, to interactively browse the Web.

In addition to the nightmare of wiring all these devices, the functionality of the system setup represented in FIG. 6 is very limited, because there is no true integration of the devices. Another disadvantage of this setup is that the TV quality degrades from box to box because almost all of the boxes send out an analog S-video or regular video signal, if not a channel 3 modulated signal (channel 3 or 4 typically), which after such a series of modulation/demodulation badly degrades.

FIG. 7 shows a novel approach to solve these problems. Set-top box 710 has an input 720, has a dual-tuner design (tuners 711 and 712) which can capture two signals at the same time, thus allowing, for example, the viewing of one channel while from recording another, etc. 3-D video chip (it could be a 2-D chip, but a 3-D chip is preferable) 713 sends signals via port 718 to TV projection system 719. Port 718 may be any or combinations of multiple types; it may support regular video signal with TV signal, or S-video signal with TV signal, or PC-type RGB analog and/or digital signals for digital direct line LCD projection screens, etc., or for LCD projection done using VGA or XVGA-type resolution on a VGA connector.

Hard disk 716 is used to record programs but also contains operation software 721, which may be updated from time to time from a server (not shown) via connection to a WAN, such as the Internet, for example, and which in some cases may happen over the same network as TV signals arrive, or over a separate network.

Internet connection can be made either by telephone line (not shown) including modem (not shown), or one of the two tuners 711 or 712 can be configured to run as a cable modem. Alternatively, a separate cable modem (not shown) can be used.

CPU and memory blocks 714 are essentially the same as those found in a standard PC-type architecture.

Element 715 represents an MPEG encoder/decoder, which is used to record TV programs to disk 716 and play them back from disk 716 onto a screen, such as TV 719. In some cases, two decoders can be used to allow simultaneous decoding of two digital video streams from tuners 711 and 712.

Port 717 allows connection of high-speed and medium-speed external devices. In this example, DVD RAM 730 is connected to box 710 by link 731. The connection and port type could be any of a variety of standard types, including but not limited to USB, parallel, 1394, Ethernet, or any other type of fast and reliable connection.

Connecting a DVD RAM to set-top box 710 offers several advantages. It allows playing DVD movies with higher resolution, using the digital output from video decoder 713. It also allows recording or long-term storage of prerecorded movies from hard disk 716 digitally onto an empty DVD, thus allowing long-term storage that is not possible in the limited space of hard disk 716.

Today's type of disk recorder, such as TiVo or Replay, requires a VCR to be connected to a regular S-video or analog video port and/or channel 3 RF video, and recording is done via that connection, which further reduces quality. By allowing DVD RAM 730 to be connected digitally to hard disk 716, such long-term storage can be achieved without any loss of quality.

Depending on the capacity of interface 731, this recording and play-back may take more time than the playing of the actual movies, which means in some cases play-back may require the movie to be first copied onto hard disk 716 before it can be viewed.

Also not shown is a surround sound output that would deliver digital signals, including control commands for the surround sound receiver, or alternatively the system could deliver surround sound out of this box 710.

In essence, box 710 without the software is not much different from what is known as a general instrument 5000 box, which is a dual-tuner design with built-in hard disk. Lots of other vendors have similar or equivalent boxes with dual-tuner design, and have suitable ports 717 to connect, for example, a DVD RAM, and have suitable ports 718 to also connect digitally a TV or projection system.

It is clear that in some cases the DVD RAM maybe integrated, or may be a plug in module, rather than an external peripheral, and in some other cases, the DVD RAM recorder will be a separate device. Also, additional interfaces for VCRs and for other peripherals can be incorporated into the system, to provide backward compatibility. Additionally, in some cases so-called IR blasters may be used to send commands to those older, devices. In some cases, a separate command path may exist, or be integrated with a 1394-type digital video interface, allowing for direct control of all devices.

Also, the same type of computing devices described earlier in this embodiment can be used to control such an integrated system as represented in FIG. 7. Alternatively, the system may also feature a network interface or wireless interface (not shown), to allow one or more local or remote computing devices to control the system.

Further, this type of system allows a single-button recording function to be available in an integrated electronic programming guide (EPG), thus permitting the user to either record to the hard disk, the DVD RAM, or both in parallel or in sequence, by offering the user his choice of commands in the EPG (not shown). Such option buttons are well known and not new in themselves, but the availability of a single-button recording to a removable media without requiring the user to manually set up the media before recording is quite novel. This novel capability can be offered, by permitting the user to record onto the hard disk, and at a later time, prompting the user to provide an empty medium on which to copy the content.

Yet furthermore, analog broadcasts can be digitally recorded, but digital broadcasts could be digitally recorded as well. In combination with multiple digital video decoders and/or encoders, it may be possible, for example, to view a DVD while recording a digital broadcast onto the hard disk, and at a later time transfer the recorded digital broadcast with ancillary information, as known to the inventor in copending iSurfTV Corporation application No. 09/858,762 filed May 15, 2003 titled “Transparent Object Management for Removable Media Recorders” (attorney docket no. 4688.P022) onto a DVD.

It is well known in the art that different combinations of similar devices can be used, and different mixes between software and hardware can be applied, to essentially attain the same functions, and all those options shall be regarded as equivalent. For example, DV encoding/decoding can be done in software by a CPU, digital signal processor, or with a dedicated chip, or partially with a chip and software support. Also, instead of DVD RAM, any type of digitally recording (one or many), removable media can be used, such as optical, magnetic, laser magnetic, tape, cartridge, flash, etc.

### DESCRIPTION OF EMBODIMENT

One embodiment provides a method and apparatus for integrating an entertainment system to prevent confusion and signal loss. In the following description, for purposes of explanation, specific details are set forth to provide a thorough understanding of the present invention. However, it will be apparent to one skilled in the art that these specific details are not required in order to practice the present invention.

An EPG allows a user to perform a range of functions that may be useful when watching television. Commonly assigned U.S. patent application Ser. No. 09/488,361, filed Jan. 16, 2000, describes in more detail the functions of an EPG and is hereby incorporated by reference

The main function of an EPG is to allow a user to view program listings sorted by channel and time. Newer EPGs allow a user to browse through the listings, and to get detailed information about specific programs. EPGs may also allow a user to select certain channels or programs in which the user is particularly interested. Additionally, an EPG may control a recording device, and start recording when programs selected by the user are shown.

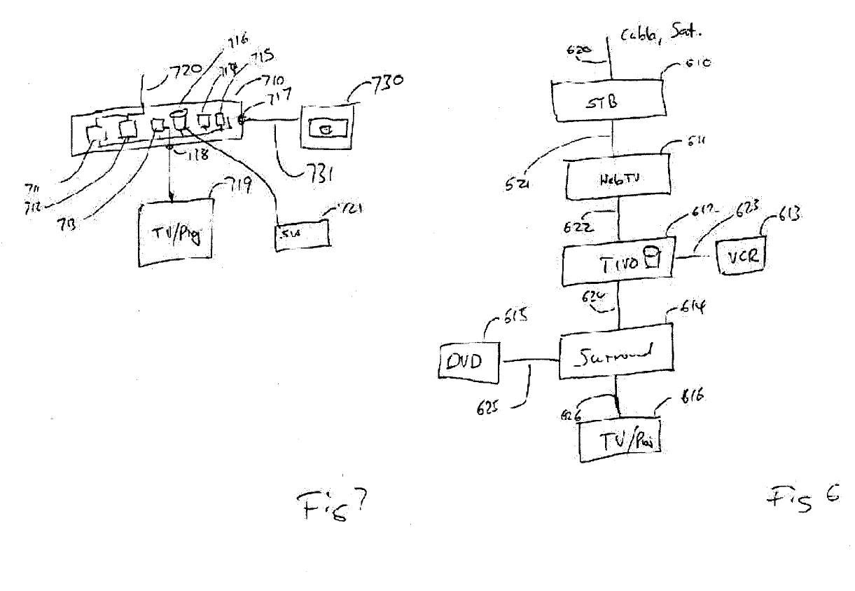

FIG. 39-2 illustrates an integrated entertainment system. Current entertainment systems contain many different components. Setting up an entertainment system is typically very difficult, and additionally analog signals that are passed from component to component can significantly degrade.

Entertainment system 100 comprises a set top box (STB) 105, a television or other video display 110, and a digital versatile disc—random access memory (DVD-RAM) drive or other recording device 115. STB 105 processes the signals sent by a service provider, and its function is further described below. Video display 110 displays video signals outputted by STB 105, and may be a television, projection system, plasma screen, liquid crystal display (LCD) or any other device capable of displaying video signals. Recording device 115 can be attached to STB 105 to receive either digital or analog signals, and may be a DVD-RAM drive, a video cassette recorder (VCR), or any other device capable of recording video.

STB 105 further comprises an signal input 120, dual tuners 125 and 130, video circuitry 135, an output port 140, a hard drive 145, a central processing unit (CPU) and memory system 150, an digital video encoder/decoder 155, and a digital input/output port 160. The combination of these devices into STB 105 reduces the complexity of a home entertainment system. STB 105 performs the functions of a typical set top box, a hard drive-based digital recording device, an Internet connectivity device, and may also include hardware to process audio signals. Further, because of the relatively small number of connections within STB 105, signal degradation is significantly reduced. Also, many connections within STB 105 may be or are digital connections, and will not affect the signal in any way.

A signal may be routed into STB 105 using input 120. Signals may be received from any of a number of sources, including cable, satellite and antenna. The signal is then sent to tuners 125 and 130. STB 105 may contain one or more tuners; with two tuners, it is possible to have picture-in-picture (PIP) functionality. Also, one or more tuners may be configured to be a cable modem to facilitate Internet connectivity.

Video circuitry 135 may be,either a two dimensional or three dimensional graphics chip for displaying an Electronic Programming Guide (EPG) or other information on video display 110. Signals are sent from video circuitry 135 to video display 110 through output port 1:40.

Hard drive 145 is capable of storing video encoded by CPU 150 and video encoder/decoder 155. Hard drive 145 further contains operations software 165, which controls the functions of STB 105. Software 165 may also be updated via a network or other means when updates are necessary. Video encoder/decoder 155 may encode and decode digital video using the Moving Picture Experts Group (MPEG) standard or any other method of encoding and decoding digital video. Hard drive 145 may also send data through port 160 to recording device 115.

STB 105 may further include a modem (not shown) to connect to the Internet or other online services. Also, output port 140 may be configured to accept high or medium speed devices, possibly using universal serial bus (USB), parallel, FireWire™, Ethernet or other connections.

Additionally, current hard drive based recording systems, such as TiVo™ and ReplayTV™, make permanent copies of recorded programs by writing to a cassette tape. STB 105 can record to a DVD-RAM, providing a higher-quality and more permanent recording.

STB 105 can also be connected to a stereo or surround-sound receiver. It is also possible to integrate hardware necessary to produce audio and to provide more functionality and integration. DVD-RAM drive 115 may also be integrated into STB 105 if desired. Entertainment system 100 may be controlled by a remote computing device such as computing device 150 (see FIG. 39-2).

Entertainment system 100 can further provide this functionality without requiring a user to insert blank media or to reconfigure STB 105. A user may instruct STB 105 to record a program. The program will then be recorded to hard drive 145, using video encoder/decoder 155. At a later time, a user can insert a blank media, and instruct STB 105 to record to that blank media. This way, if a user does not have any blank media, or simply does not wish to set up the system at that time, the user may still record the desired program.

Entertainment system 100 can also provide for single-button recording to a digital media. In one embodiment, in response to a user making a single button selection, a selected program and auxiliary information related to the program is transferred from a storage device in the STB to a removable storage device. In one embodiment, the removable storage device may be a DVD-RAM. In alternative embodiment, other types of removable storage devices may be used.

The single button selection may include the selection of a button on a panel of the STB or a panel on a remote control. The remote control may also be a personal digital assistant and/or a web phone.

Recordings made can be sourced out to a spindle farm, a DVD-RAM jukebox or any other massive storage medium. Recordings can be made and organized using the EPG provided to the STB 205. Such methods should be able to store massive amounts of data and a significant amount of video. For example, programs and their related auxiliary data could be indexed by the STB onto the jukebox or other storage device. When a user selects a program that is stored on a removable storage, the STB would prompt the user to insert the removable storage containing the selected program.

Several alternative embodiments of entertainment system 100 exist. Video encoding and decoding can be performed by software stored on hard drive 145 and processed in CPU 150. Or, a combination of software and hardware instruction for encoding and decoding video is possible. Also, many different types of recording media can be used, such as: optical, magnetic, laser magnetic, tape, cartridge, or flash random access memory (RAM).

The system and method described herein may be integrated into advanced Internet-or network-based knowledge systems as related to information retrieval, information extraction, and question and answer systems. FIG. 39-3 is an example of one embodiment of a computer system 300. The system shown has a processor 301 coupled to a bus 302. Also shown coupled to the bus 302 is a memory 303 which may contain instructions to perform the method described herein. Additional components shown coupled to the bus 402 are a storage device 405 (such as a hard drive, floppy drive, CD-ROM, DVD-ROM, etc.), an input device 406 (such as a keyboard, mouse, light pen, barcode reader, scanner, microphone, joystick, etc.), and an output device 407 (such as a printer, monitor, speakers, etc.). Of course, an exemplary computer system could have more components than these or a subset of the components listed.

The system and method described herein may be stored in the memory of a computer system (i.e., a set-top box) as a set of instructions to be executed, as shown by way of example in FIG. 39-3. In addition, the instructions to perform the system and method described herein may alternatively be stored on other forms of machine-readable media, including magnetic and optical disks. For example, the system and method of the present invention may be stored on machine-readable media, such as magnetic disks or optical disks, which are accessible via a disk drive (or computer-readable medium drive). Further, the instructions may be downloaded into a computing device over a data network in the form of a compiled and linked version.

Alternatively, the logic to perform the system and method described herein may be implemented in additional computer and/or machine-readable media such as discrete hardware components as large-scale integrated circuits (LSI's), application specific integrated circuits (ASIC's), firmware such as electrically erasable programmable read-only memory (EEPROM's), and electrical, optical, acoustical, and other forms of propagated signals (e.g., carrier waves, infrared signals, digital signals, etc.).

The embodiments above have been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the embodiments as claimed. Accordingly, the scope is defined by the appended claims rather than the forgoing descriptions of embodiments.

As previously described above, FIG. 1 displays the television viewing system 100 with, for example, a set-top box 101, a recording or storage device 103, a television set 102, and its local remote controller 104. As discussed earlier, element 110 is a remote computing device. It may be connected either via network 120 to a server 130, or to set-top box 101, or in some cases, directly through another link 124 to the set-top box.

As also mentioned earlier, this computing device may in some cases be a telephone; and in some cases audio commands may be given; and in some cases, the response, rather than just appearing on screen 102 or on local screen 112, may be given as an audio response, as is more safe while driving a car, for example.

This computing device 110 may be located remotely from TV system 100 or it may be at the same location as system 100; and it may have any of various levels of integration into the control system of set-top box 101. In some cases, for example, server 130 may have some voice to IP command translation facilities, such as is currently know as VoxML, to translate voice commands into the kinds of commands that are understood by software or computers, such as set-top box 101, and, vice versa, responses of box 101, such as lists, may be then read back by text-to-voice synthesis for easier access.

Also in some cases, audio content from box 101 may be redirected to a phone device or computing device with a speaker (not shown).

In the claims:

1) An apparatus comprising:
a first unit to provide an Electronic progaming guide (EPG);
a second unit to operate the EPG in response to voice commands; and
a third unit to produce an audibile response.
